(19) United States
(12) Patent Application Publication
(10) Pub. No.: US 2004/0101267 A1
(43) Pub. Date: May 27, 2004

(54) Optic fiber attenuator

(75) Inventors: Milfred Earnest Thomas, Santa Ana, CA (US); Minh Chi Du, Garden Grove, CA (US)

Correspondence Address: Leon D. Rosen, Freilich, Hornbaker & Rosen, Suite 1220, 10960 Wilshire Blvd., Los Angeles, CA, 90024, US

(73) Assignee: ITT Manufacturing Enterprises, Inc.

(21) Appl. No.: 10/307,067

(22) Filed: Nov. 27, 2002

(51) Int. Cl. G02B 6/00

(52) U.S. Cl. 385/140; 385/137

(57) ABSTRACT

An optic fiber attenuator of the type wherein a length (30) of optical fiber extends in a loop (34) to decrease light intensity, which is easily manufactured to a precise attenuation level. The attenuator, or attenuator arrangement, includes a quantity (36) of solidified resin that encapsulates the loop (34). The loop extends at least about 360° and has an intertwinement (110) to hold the loop orientation of the fiber middle portion (32) during manufacture. To form the attenuator, a length of optical fiber is turned into a loop with an intertwinement, and the loop is placed in a cavity (80) and around a pin (82) in the cavity. A flowable polymer is injected into the cavity to fill it. While the polymer remains flowable, at least one end of the fiber is pushed or pulled to increase or decrease the diameter of the loop, while the attenuation of the fiber is measured. When the proper attenuation is achieved, ultraviolet light (130) is applied to the resin to harden it. A group of attenuators is mounted in a shell (20), with termini (56, 52) at opposite ends of the fiber projecting through passages (54) in a body (22) at the front end of the shell, and with the encapsulated loops of the attenuators lying in the shell and overmolded with a potting material (62).

### BACKGROUND OF THE INVENTION

There is a need for attenuators to accurately attenuated light passing through an optical fiber. For example, a high intensity light source may be used to provide light to a fiber optic network to assure there is sufficient light reaching all sensors. Sensors not located very far from the light source should not be saturated, and this can be accomplished by providing an attenuator to reduce the light intensity reaching any particular sensor. It is known that the intensity of light passing through an optical fiber is reduced when the fiber is bent into a sharp curve. This is due to light which passes along the core of the fiber and which is reflected by the cladding that surrounds the core, reaching the cladding at larger angles due to the bending, and causing some of the light to pass through the cladding and be lost. However, applicant does not know of closely controlled bending of optical fibers to achieve precise attenuation.

### SUMMARY OF THE INVENTION

In accordance with one embodiment of the present invention, an attenuator arrangement and method for construction are provided, which result in an optical fiber attenuator whose attenuation can be precisely controlled, which of small size, and which can be manufactured at low cost. The attenuator includes a length of optical fiber with a middle portion that forms a loop. A quantity of solidified encapsulating material, such as a set resin, surrounds the looped middle portion of the fiber, to fix the size and shape of the loop. That is, the encapsulating material fixes the angle of wrap of the loop as well as the diameter of the loop.

The loop extends by at least about 360° and includes an intertwinement wherein a location along the fiber loop extends through a 360° turn of the loop. This provides friction that tends to keep the fiber in the loop configuration to which it is moved. The encapsulating material is preferably a settable resin that is initially flowable and that is solidifyable by application of energy such as ultraviolet light. The loop preferably extends by an integer (e.g. 1) times 360°, plus an angle of 90° to 270°, so the opposite sides of the loop extend primarily parallel to one another. A number of attenuators have the encapsulated and looped attenuator portion lying in a closed rear portion of a shell, while termini at opposite ends of each length of optical fiber are mounted in passages of a body lying at the front end of the shell. The plurality of encapsulated loop portions are held in place with an overmold of potting material lying in the shell.

A length of optical fiber is first bent into a loop, preferably a loop of at least 360° and with an intertwinement. The loop is placed in a molding cavity, with a pin extending through the center of the loop. Opposite end portions of the fiber extend through grooves in the mold, to termini that are coupled to a test instrument. The test instrument directs light into one terminus and detects the amplitude of light received from the opposite terminus, and displays the attenuation. A resin in a flowable state is injected into the cavity. One or both end portions of the fiber are pushed to expand the diameter of the loop so as to decrease attenuation, or pulled to decrease the diameter of the loop to increase attenuation, until the desired attenuation is achieved. Then, the pin is removed from the cavity and energy such as ultraviolet light is applied to the resin to solidify it.

The novel features of the invention are set forth with particularity in the appended claims. The invention will be best understood from the following description when read in conjunction with the accompanying drawings.

### BRIEF DESCRIPTION OF THE DRAWINGS

FIG. 1 an exploded isometric view of an assembly of optical fiber attenuators and a container that includes a shell and body, constructed in accordance with the present invention.

FIG. 2 is a sectional view of one attenuator of the apparatus of FIG. 1.

FIG. 3 is a sectional view taken on line 3-3 of FIG. 2.

FIG. 4 is an isometric view of fabrication apparatus used in the construction of the attenuator of FIG. 2.

FIG. 5 is a view similar to FIG. 4, showing how the optical fiber is placed in the cavity, how settable resin encapsulant is placed in the cavity, how the attenuation is measured, and indicating the application of solidifying energy to the encapsulant.

FIG. 6 is a sectional view of an optical fiber attenuator of another embodiment of the invention.

FIG. 7 is a partially sectional isometric view of an optical fiber of the type used in the attenuators of FIGS. 1-3 and 5-6.

### DESCRIPTION OF THE PREFERRED EMBODIMENTS

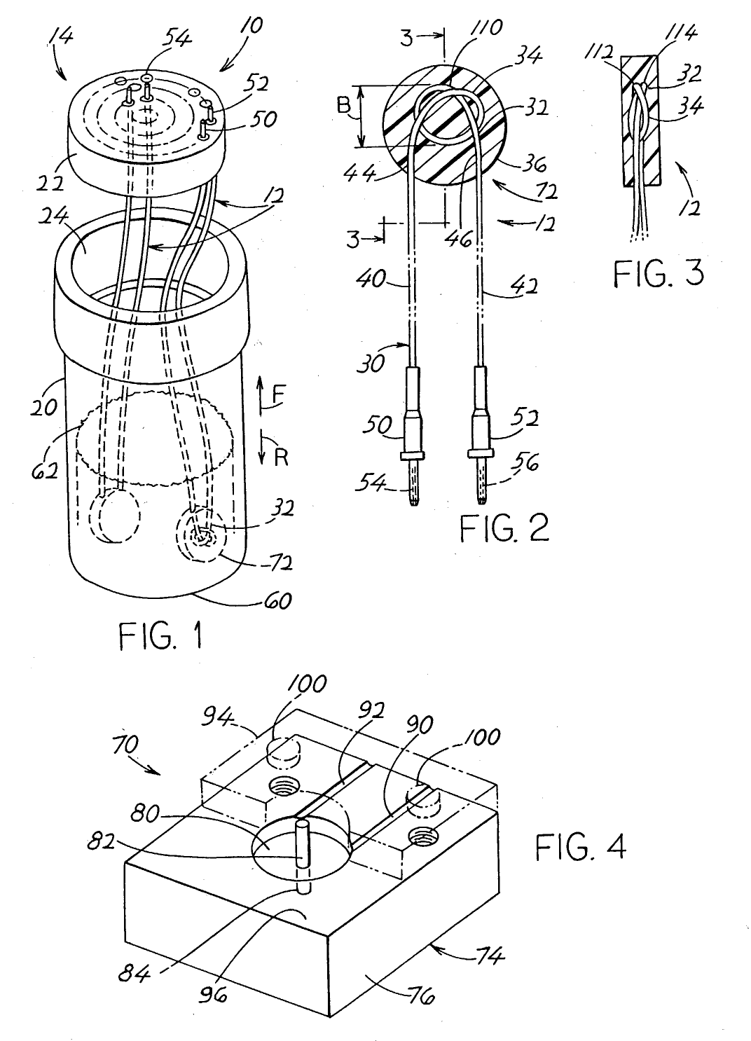

FIG. 1 illustrates an arrangement 10 of optical fiber attenuators 12 mounted in a container 14 that includes a shell 20 and a body 22 that substantially closes an open front end 24 of the shell. Each of the attenuators 12 has a construction such as shown in FIGS. 2 and 3. The attenuator includes a length 30 of optical fiber which has a middle portion 32 wound into a loop 34. A quantity 36 of encapsulating material, preferably a polymer and preferably a polymer that can be set, encapsulates the loop 34. The length of optical fiber has end portions 40, 42 with proximal parts 44, 46 that extend from the loop 34 and that lie within the encapsulating polymer quantity 36. Termini 50, 52 surround extreme ends 54, 56 of the optical fiber, and allow light in the fiber to be coupled to light in other fibers by the tips of mating fibers abutting one another, in a well known manner. After each attenuator 12 has been constructed, the termini 50, 52 are projected through passages 54 (FIG. 1) in the body 22 and the body is fixed in the open front end 24 of the shell. The shell has a closed rear end 60, and the encapsulated middle portions 32 lie near the rear end of the shell. After all the optical fiber lengths are formed with a loop that is encapsulated, and with termini mounted in the body 22, a potting material 62 such as a settable resin, is poured into the shell and hardened, as with the application of ultraviolet light.

FIG. 4 illustrates a fabrication apparatus 70 which is used to form the optical fiber attenuator 12 of FIG. 2, and particularly a middle part 72 of the attenuator. The fabrication apparatus 70 of FIG. 4 comprises a mold 74 with a mold part 76 having a cavity 80. A pin 82 has a lower portion 84 lying in a hole at the bottom of the cavity, and has an upper portion extending through the cavity. The mold part has a pair of grooves 90, 92 through which the proximal parts of the fiber extend during fabrication. A hold-down 94 can be fastened to an upper surface 96 of the lower mold part by a pair of screws 100.

FIG. 5 shows steps taken in the fabrication of the optical fiber attenuator. First, the length of fiber 30, which has been fitted with the termini 50, 52, has its middle portion 32 wrapped into the loop 34. The loop preferably includes a turn 112 of at least about 360°, and a location 114 along the fiber that extends through the turn 112 to form an intertwinement 110. As shown in FIG. 3, this results in friction between adjacent portions of the fiber extending in the turn, which helps hold the fiber in the loop configuration.

Referring to FIG. 5, it can be seen that with the loop 34 lying in the cavity 80, and with the termini 50, 52 at the opposite ends of the fiber connected to a test instrument 120, the attenuation of light passing through the length of optical fiber 30 is measured by the instrument 120. If the attenuation is greater than desired, one or both end portions 40, 42 of the fiber are moved inwardly I to expand the diameter of the loop 34. If the attenuation is not great enough, than one or both end portions are moved outwardly O to decrease the diameter of the loop and thereby increase attenuation. When the desired degree of attenuation is achieved, the orientation of the loop 34 is fixed by the hold-down 94 which clamps inner parts inner part 124 of the fiber end portions, that lie in the grooves.

Applicant can apply flowable resin 36A into the cavity 80 either before or after the precise diameter of the loop is fixed at which the desired attenuation is achieved. Applicant prefers to apply the resin 36A prior to final testing and adjustment of the loop, to reduce the number of steps required during which the loop might change orientation. Accordingly, soon after the loop 34 is placed in the cavity, sufficient flowable resin 36A is applied, as through a syringe 122 to the cavity to fill it and thereby mold resin around the loop. After the loop has been installed, applicant places the hold-down 94 over those parts of the fiber end portions 40, 42 that lie in the grooves of the lower mold part, but does not fully tighten the screws 100. After the desired orientation of the loop has been achieved, the screws 100 are tightened to clamp the fiber end portions in place, and ultraviolet light, indicated at 130, is applied to the resin that previously had been injected into the cavity to fill it. The ultraviolet light solidifies the resin, to thereby trap the loop in orientation within the quantity of encapsulatant resin that fills the cavity. It is noted that prior to applying the ultraviolet light at 130, applicant removes the pin 82.

FIG. 7 shows the construction of the length of optical fiber 30, which includes a glass core 140, a glass cladding 142 that surrounds the core, and a jacket 144 that commonly includes two jacket parts 146, 148. In the particular fiber 30 that applicant has used, the core 140 had an outside diameter C of 62.5 um, the cladding 142 had an outside diameter D of 125 um, and the jacket 144 had an outside diameter A of 0.8 mm. The diameter B (FIG. 2) of the loop should be on the order of magnitude of 200 times the diameter C of the core 140 in order to obtain significant attenuation of light, such as an attenuation on the order of magnitude of 4 decibels, without excessive stress on the core or cladding. The diameter of the loop should be no less than about thirty times the diameter D of the cladding to avoid the danger of cracking of the glass of the cladding. Applicant has found that if the diameter of the loop is less than about ten times the diameter A of the optic fiber jacket, that the loop will tend to slip as it expands to a diameter of about 8 mm which is about ten times the diameter A of the jacket. Accordingly, applicant uses a loop diameter A of about 8 mm, because the loop tends to retain the orientation in which it is placed, and to take any slight expansion or contraction of the loop, and to produce a small attenuator middle part 72. A larger diameter could be used, but this would result in a larger middle portion 72 (FIG. 2) that would have to be stored in an attenuator container. A loop diameter of about ten times the jacket diameter A (five to twenty times) is preferred.

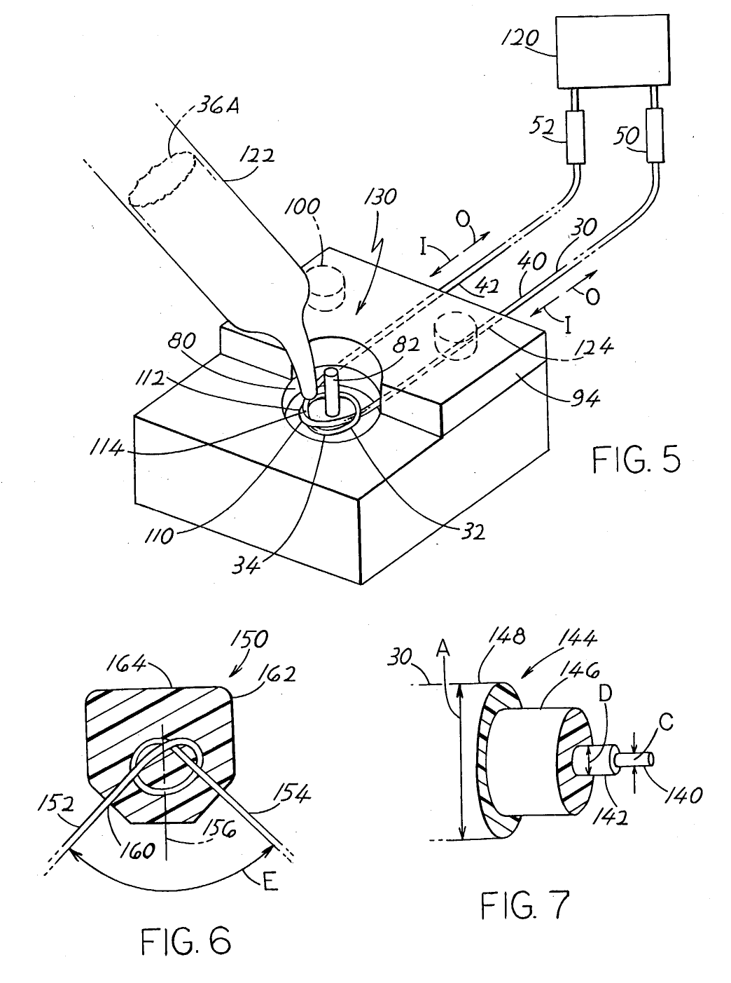

In FIG. 2, the loop 34 extends by a full turn of 360° plus an additional half turn of 180°, for a total of 540°. This results in the end portions 40, 42 extending parallel and in the same direction from the middle portion 72 of the attenuator. This facilitates mounting of the attenuator. FIG. 6 shows an attenuator 150 of another construction, wherein the loop extends by 360° plus 90°, for a total of 450°. This results in the fiber end portions 152, 154 extending at an angle E of 90° to each other. In many applications this is not as desirable because the end portions 152, 154 often must be bent to extend into adjacent holes in a body of a container. The angle E between the fiber end portions is preferably no more than 90°, to minimize such bending at locations such as 160. This is achieved by wrapping the fibers to form the loop, by an integer (0, 1, 2, etc.) times 360° plus 90° to 270°.

In an attenuator of the construction illustrated in FIG. 2 that applicant has constructed, the fiber had the construction shown in FIG. 7, with an outside diameter A of 0.8 mm and a core diameter C of 0.062 mm. The loop had a diameter of about 8 mm, and the attenuator was adjusted during construction to produce an attenuation of 4.4 db±0.2 db.

Thus, the invention provides an optical fiber attenuator or attenuator arrangement, which has a small volume and which can be easily constructed with an accurately set attenuation level. The attenuator includes a length of optical fiber with a middle portion that is wrapped into a loop, preferably comprising at least one full turn, and a quantity of solidified encapsulating material which surrounds the loop to fix its size and shape. The loop preferably includes an intertwinement, wherein the loop includes at least one approximately 360° turn and a location along the fiber that extends through the 360° turn, to hold the fiber in a somewhat tight loop. The loop preferably extends by an integer times 360°, plus 90° to 270°. The encapsulating material is preferably a resin that is initially flowable and that can be solidified by applying energy such as ultraviolet light to it. The attenuator can be part of an assembly that includes a shell with a closed rear end and an open front end occupied by a body with passages through which ferrules of the attenuator extend and where they are mounted, and with potting material lying around the middle portions of the attenuators. An attenuator is constructed by forming a loop, preferably with an intertwinement, and placing it in a cavity, preferably around a pin lying temporarily in the cavity. Flowable polymer may be applied to the cavity and a lose clamp can be placed for easy clamping of fiber end portions to fix the loop size when the desire attenuation is achieve. Ends of the fiber are monitored by a test instrument for attenuation level. When the attenuation level is achieved, the clamp is clamped to fiber end portions. Then the polymer is solidified, as by applying ultraviolet light to it.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. An optical fiber attenuator arrangement, comprising:
a length of optical fiber with a middle portion that forms a loop;
a quantity of solidified encapsulating material which surrounds said middle portion, to fix the size and shape of the loop.

2. The arrangement described in claim 1 wherein:
said optical fiber has an outside fiber diameter, and said fiber is sufficiently resilient that it tends to straighten when bent into a simple loop;
said loop includes an intertwinement wherein said fiber forms at least about a 360° turn, and a location along said fiber extends through the 360° turn, whereby the middle portion tends to hold itself in the loop configuration.

3. The arrangement described in claim 1 wherein:
said encapsulating material is a resin of a type that is initially flowable and that is solidifyable by application of energy to the resin, whereby to facilitate adjustment of the loop while the resin surrounds the loop and is flowable and to then harden the resin when a desired attenuation is achieved.

4. The arrangement described in claim 1 wherein:
said loop extends by an integer times 360° plus an angle of 90° to 270°, whereby ends of the optical fiber on opposite sides at the loop extend primarily parallel.

5. The arrangement described in claim 1 including:
a shell with an open front end and a closed rear end;
a body lying in said shell open front end, said body having a plurality of through passages;
said length of optical fiber has opposite ends, and including a pair of termini lying at said opposite ends of said fiber, each terminus lying in one of said passages, and said fiber middle portion and said loop lying in said shell rearward of said body.

6. The arrangement described in claim 1 wherein said length of optical fiber has a core and a cladding surrounding the core, and wherein:
said loop has a diameter that is on the order of magnitude at 200 times the diameter of the core.

7. The arrangement described in claim 1 wherein said optical fiber has a jacket with a jacket outside diameter (A), and wherein:
said loop has a diameter of about 10 times the diameter of said jacket.

8. An optical fiber attenuator arrangement, comprising:
a shell with an open front end and a closed rear end;
a body lying in said shell open first end, said body having a plurality of through passages;
at least a first attenuator which includes a length of optical fiber that includes a core of predetermined core diameter, a cladding that lies around the core, and a jacket that surrounds the cladding, said length of optical fiber having opposite ends and a pair of termini, each terminus fixed to one of said fiber ends and lying one of said passages in said body, said length of optical fiber having a middle that extends in a loop with a radius of curvature on the order of magnitude of 200 times the core diameter;
a quantity of solidified polymer that is molded around said loop, said loop and quantity of polymer lying in said shell behind said plate.

9. The arrangement described in claim 8 including:
a plurality of attenuators, including said first attenuator, that each includes a loop embedded in a separate quantity of solidified polymer and a pair of termini each lying in one of said passages in said body;
a quantity of potting material that fills at least a rear portion of said shell and that overmolds said quantities of solidified polymer.

10. The arrangement described in claim 8 wherein:
said loop includes at least one turn of about 360°, and includes an intertwining wherein a location along the fiber extends through the turn, whereby the middle portion tends to retain itself in the loop configuration.

11. A method for constructing an optic fiber attenuator, comprising:
forming a loop in a middle portion of a length of optical fiber and placing said loop in a cavity;
placing a polymer in the cavity around the loop, and causing said polymer to harden.

12. The method described in claim 11 wherein said length of optical fiber has opposite ends, and including:
measuring attenuation along said length of optical fiber, including passing light through said optical fiber between its ends, and measuring the attenuation of the light;
said step of forming a loop comprises forming a loop of a predetermined total loop angle equal to an integral number of complete turns plus a predetermined angle, between ends of the loop; and
varying the average radius of curvature of the loop without changing the total loop angle, and measuring attenuation until a desired attenuation is established, and then causing the polymer to harden.

13. The method described in claim 12 wherein:
said step of placing a polymer in the cavity includes placing a flowable polymer in the cavity and maintaining it in a flowable state while performing said step of varying the average radius of curvature, and only then applying energy to said polymer to harden it.

14. The method described in claim 12 including:
establishing a pin at a center of said cavity and establishing said loop around said pin;
prior to causing said polymer to harden, removing said pin from said cavity.

15. The method described in claim 12 wherein said loop has opposite sides, said length of optical fiber has opposite ends, and said length of optical fiber has fiber end portions extending from each side of said loop to one of said ends, and including:
placing each of said fiber end portions in a slot of a mold that also forms said cavity;
pushing and pulling said fiber end portions along said slots to respectively decrease and increase the attenuation of the loop, and upon reaching a desired attenuation, clamping said fiber and portions in said slots.

16. The method described in claim 11 wherein:
said step of forming a loop includes forming a loop of at least about 360°, with an intertwinement, whereby to tend to hold the loop in an orientation at which it is placed.
